(19) United States
(12) Patent Application Publication
(10) Pub. No.: US 2008/0307323 A1
(43) Pub. Date: Dec. 11, 2008

(54) CALENDARING TECHNIQUES AND SYSTEMS

(76) Inventors: Patrick Lee Coffman, Menlo Park, CA (US); Manuel Colom, Paris (FR); Scott Joseph Adler, Menlo Park, CA (US); Lala Dutta, Cupertino, CA (US); Matthew Elliott Shepherd, San Francisco, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/760,779

(22) Filed: Jun. 10, 2007

(51) Int. Cl. G06F 3/048

(52) U.S. Cl. 715/753

(57) ABSTRACT

The calendaring techniques and systems described herein enable a user to more easily resolve conflicts for attendees to an event by visually indicating available time slots for all attendees in a calendar window or in a timeline window separate from the calendar window. The first available time slot may be automatically selected or the user may select an available slot to reschedule the event. In another aspect, inspector windows are displayed within a calendar window to show summary or details for an event. An inspector window can also be displayed when a change to an event is detected. In yet another aspect, calendars for multiple accounts accessible by a user are merged into a single calendar view.

### BACKGROUND OF THE INVENTION

The present inventions relate to managing an electronic calendar.

An electronic calendar is typically implemented on a data processing system, such as a general purpose computer system or a personal digital assistant (PDA) or a cellular telephone or a media player (e.g. an iPod) or other types of devices. These electronic calendars typically allow a user to display different time intervals or time ranges within a calendar. For example, an electronic calendar will typically allow a user to display at least a portion of a day, a full day, a portion of a week or a full week, several weeks, or a month, or a plurality of months, or even multiple years. The electronic calendars further typically include user interfaces for allowing a user to move between the different time durations or time ranges and to enter events and reminders onto the calendar. The events and/or reminders typically include some text specifying the event as well as data specifying the duration in time of the event and other information. A user can typically save these reminders or events at a particular time on the calendar and then later retrieve the information from the calendar to see what events are upcoming, to plan for events, etc.

Often times, an event may require several people to attend the event, such as a meeting or a party, etc. In these circumstances, the creator of the event on the calendar must determine a time when each of the attendees is free. Prior calendaring systems typically displays a timeline or other chart that shows the creator the free and busy times of all the attendees on multiple days. The timeline display is in a window separate from the calendar window for the creator. Because the entire timeline cannot fit within the window, the creator has to scroll the timeline across the window to select an open time slot for the event. If there are more attendees than can fit in the timeline window, the creator also must scroll the timeline down the window to see the scheduling information for the other attendees. In addition to being cumbersome to navigate, the prior art timeline window does not allow the creator to view the open time slots as they relate to his/her own calendar. Often the creator will need to schedule an event as it relates to other events on the creator's calendar.

Once the event is scheduled by the creator, an attendee receives an invitation to the event, such as in an electronic message, and the event is placed on the attendee's calendar. Because of the limited amount of space in a typical calendar window, the event details are hidden and are viewed by the user actively interacting with the event, such as by moving a cursor over the event and/or clicking on the event. The details of the event are displayed in a details window that is separate from the calendar window. However, the amount of information displayed in the details window may cause the details window to obscure other information on the screen. Moreover, if the user wants to modify event details, additional windows may be created to receive the user input.

Although existing calendaring systems allow a user to display multiple calendars within a single window, the calendars are typically presented as separate columns. Thus, the user is required to move between the columns to determine if conflicts exists among events on the different calendars, or to find free time to schedule an event.

### SUMMARY OF THE DESCRIPTION

The calendaring techniques and systems described herein enable a user to more easily resolve conflicts for attendees to an event. In one aspect, available time slots for all attendees is visually indicated within a calendar window that also displays the event at the original scheduled time. In another aspect, available time slots are visually indicated in a timeline window that is separate from the calendar window. The first available time slot may be automatically selected or the user may select an available slot to reschedule the event. An event marker can be displayed that snaps to the next available slot when the user moves the event marker.

In another aspect, the calendaring techniques and systems described herein display inspector windows within a calendar window. A condensed inspector window display a summary of an event in the calendar selected by a user. If an edit request is received from the user, a full inspector window is displayed within the calendar window. The full inspector window indicates those details that can be edited by the user. An inspector window can also be displayed when a change to an event is detected. The inspector event is anchored on the changed event and visually indicates the change.

In yet another aspect, the calendaring techniques and system described herein merge calendars for multiple accounts accessible by a user into a single calendar view. The multiple accounts may be on different servers. Additionally, one of the accounts may be a delegated account in which the owner of the account has granted access.

### BRIEF DESCRIPTION OF THE DRAWINGS

The present invention is illustrated by way of example and not limitation in the figures of the accompanying drawings in which like references indicate similar elements.

FIG. 1 shows an exemplary data processing system which may be used in at least certain embodiments described herein.

FIG. 2 is a flow chart which depicts an exemplary embodiment described herein.

FIGS. 3A, 3B, 3C, 3D, and 3E show examples of a user interface which includes a list of selectable calendars.

FIG. 3F shows another example of a user interface which includes a plurality of user-selectable calendars in a list, each of which may be toggled on or off and thereby shown or not shown on the user's calendar within the calendar window.

FIG. 4A shows a flow chart illustrating another exemplary method described herein.

FIG. 4B is another flow chart showing another exemplary embodiment of the methods described herein.

FIGS. 5A, 5B, 5C, 5D), 5E, and 5F illustrate exemplary user interfaces for creating an event or invitation.

FIGS. 6A, 6B, and 6C illustrate exemplary user interfaces showing how invitations may be received and displayed within a user's calendar even before the invitation is accepted.

FIGS. 7A, 7B, 7C, 7D, 7E and 7F illustrate an exemplary user interface for scheduling an event by a creator.

FIG. 8 illustrates an alternate user interface for scheduling an event.

FIG. 9 is a flowchart of an exemplary method that schedules an event.

FIGS. 10A and 10B illustrate an exemplary user interface for viewing and editing an existing event.

FIG. 11 is a flowchart of an exemplary method for viewing and editing an existing event.

FIG. 12 illustrates an exemplary user interface that merges calendars from two different accounts for a user into a single calendar view.

FIG. 13 illustrates an exemplary user interface that mergers a calendar from a delegated account and a calendar for the delegate's account.

FIG. 14 is a flowchart of an exemplary method that displays the single calendar view of FIGS. 12 and 13.

### DETAILED DESCRIPTION

The subject invention will be described with reference to numerous details set forth below, and the accompanying drawings will illustrate the invention. The following description and drawings are illustrative of the invention and are not to be construed as limiting the invention. Numerous specific details are described to provide a thorough understanding of the present invention. However, in certain instances, well known or conventional details are not described in order to not unnecessarily obscure the present invention in detail.

The present description includes material protected by copyrights, such as illustrations of graphical user interface images. The owners of the copyrights, including the assignee of the present invention, hereby reserve their rights, including copyright, in these materials. The copyright owner has no objection to the facsimile reproduction by anyone of the patent document or the patent disclosure, as it appears in the Patent and Trademark Office file or records, but otherwise reserves all copyrights whatsoever. Copyright Apple, Inc. 2006.

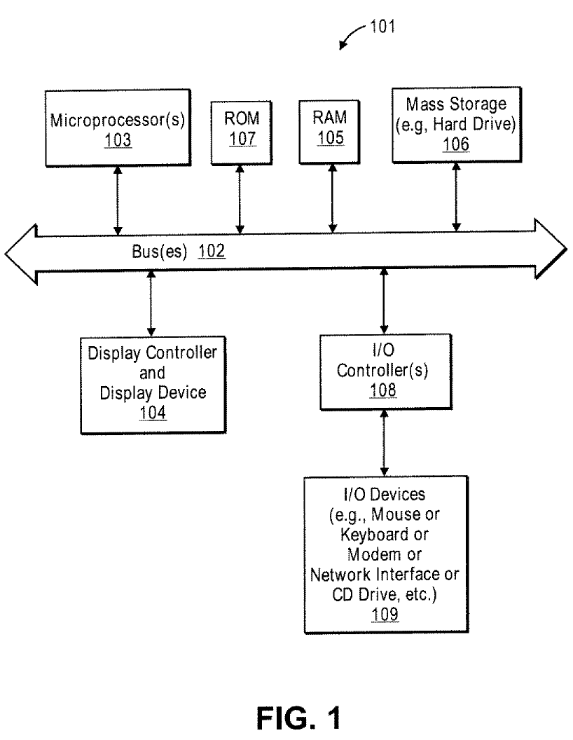

FIG. 1 shows one example of a typical computer system which may be used with the present invention. Note that while FIG. 1 illustrates various components of a computer system, it is not intended to represent any particular architecture or manner of interconnecting the components as such details are not germane to the present invention. It will also be appreciated that PDAs, cellular telephones, media players (e.g. an iPod), devices which combine aspects or functions of these devices (e.g. a media player combined with a PDA and a cellular telephone in one device), network computers, an embedded processing device within another device, and other data processing systems which have fewer components or perhaps more components may also be used to implement one or more embodiments of the present inventions. The computer system of FIG. 1 may, for example, be a Macintosh computer from Apple, Inc.

As shown in FIG. 1, the computer system 101, which is a form of a data processing system, includes a bus 102 which is coupled to a microprocessor(s) 103 and a ROM (Read Only Memory) 107 and volatile RAM 105 and a non-volatile memory 106. The microprocessor 103 may be a microprocessor or set of microprocessors from Intel or a G3 or G4 microprocessor from Motorola, Inc. or one or more G5 microprocessors from IBM. The bus 102 interconnects these various components together and also interconnects these components 103, 107, 105, and 106 to a display controller and display device 104 and to peripheral devices such as input/output (I/O) devices which may be mice, keyboards, modems, network interfaces, printers and other devices which are well known in the art. Typically, the input/output devices 109 are coupled to the system through input/output controllers 108. The volatile RAM (Random Access Memory) 105 is typically implemented as dynamic MM (DRAM) which requires power continually in order to refresh or maintain the data in the memory. The mass storage 106 is typically a magnetic hard drive or a magnetic optical drive or an optical drive or a DVD RAM or other types of memory systems which maintain data (e.g. large amounts of data) even after power is removed from the system. Typically, the mass storage 106 will also be a random access memory although this is not required. While FIG. 1 shows that the mass storage 106 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 102 may include one or more buses connected to each other through various bridges, controllers and/or adapters as is well known in the art. In one embodiment the I/O controller 108 includes a USB (Universal Serial Bus) adapter for controlling USB peripherals and an IEEE 1394 controller for IEEE 1394 compliant peripherals.

It will be apparent from this description that aspects of the present invention may be embodied, at least in part, in software. That is, the techniques may be carried out in a computer system or other data processing system in response to its processor, such as a microprocessor, executing sequences of instructions contained in a memory, such as ROM 107, RAM 105, mass storage 106 or a remote storage device. In various embodiments, hardwired circuitry may be used in combination with software instructions to implement the present invention. Thus, the techniques are not limited to any specific combination of hardware circuitry and software nor to any particular source for the instructions executed by the data processing system. In addition, throughout this description, various functions and operations are described as being performed by or caused by software code to simplify description. However, those skilled in the art will recognize what is meant by such expressions is that the functions result from execution of the code by a processor, such as the microprocessor 103.

One example of a computer program which may implement one or more methods described herein is the computer program called iCal from Apple, Inc. of Cupertino, Calif. Further information about this computer program is also provided by published U.S. Patent Application No. US2004/0044646, which published application is hereby incorporated herein by reference.

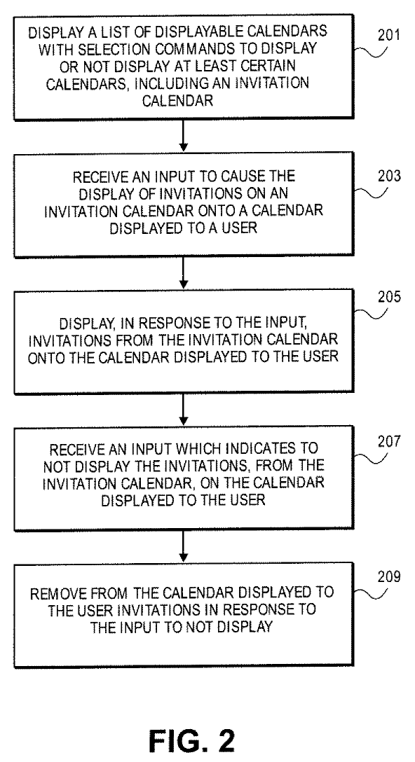

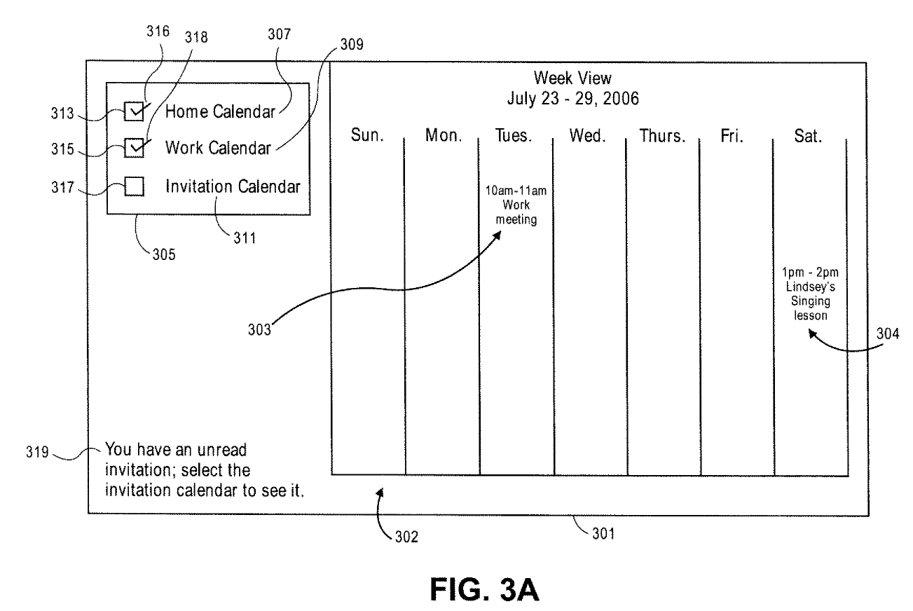

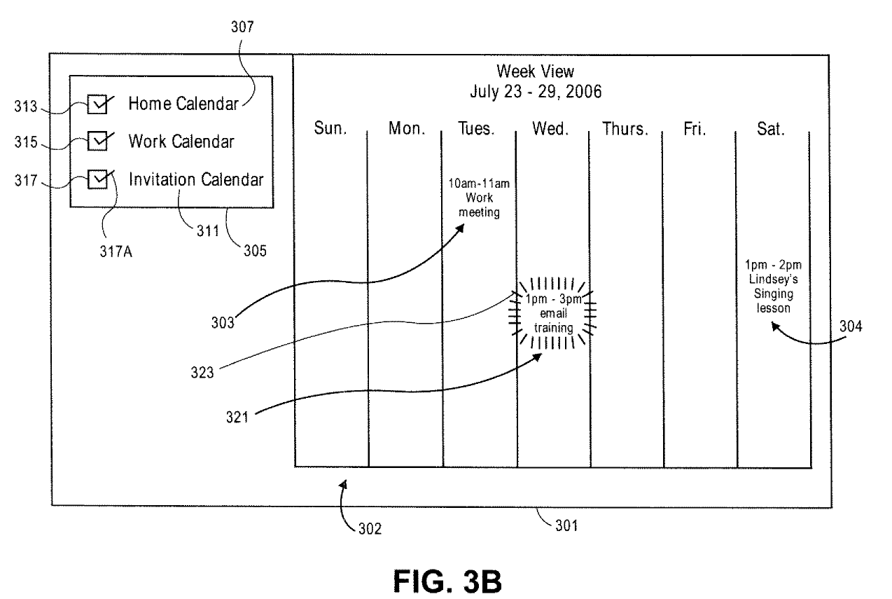

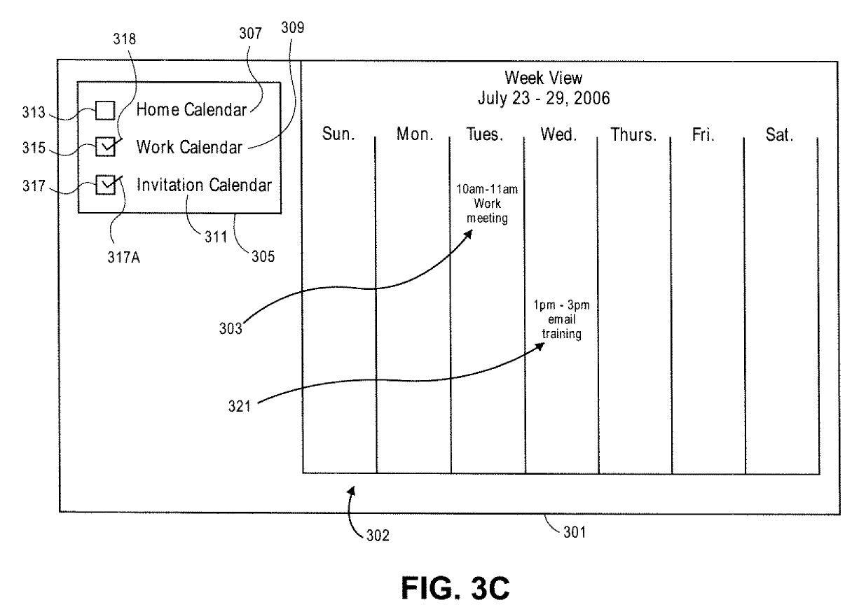

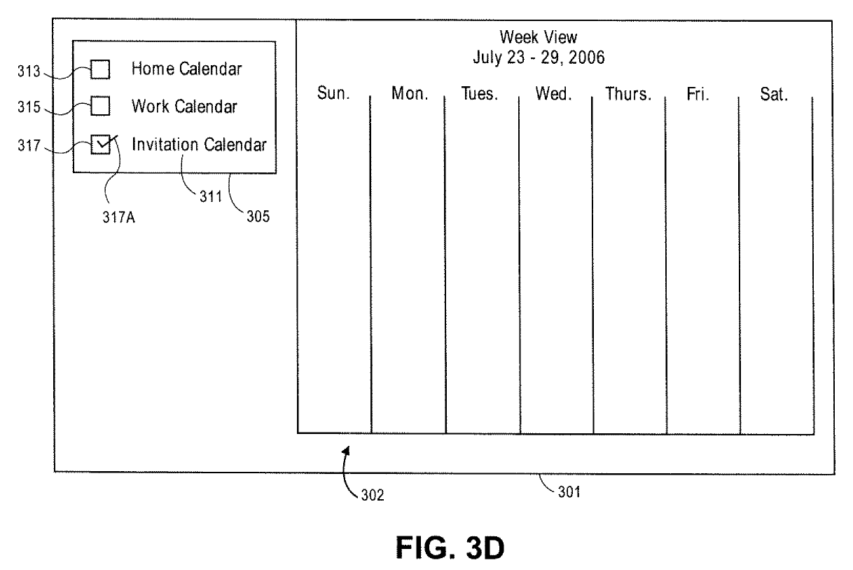

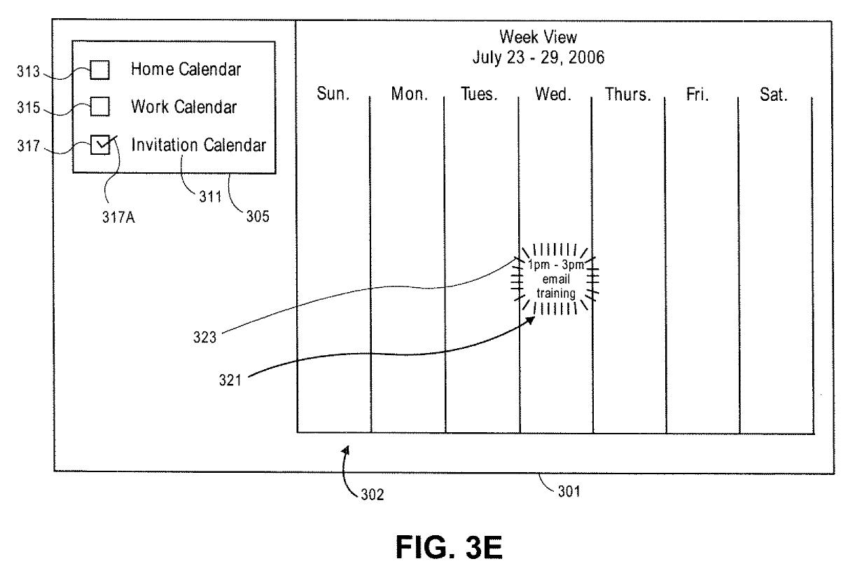

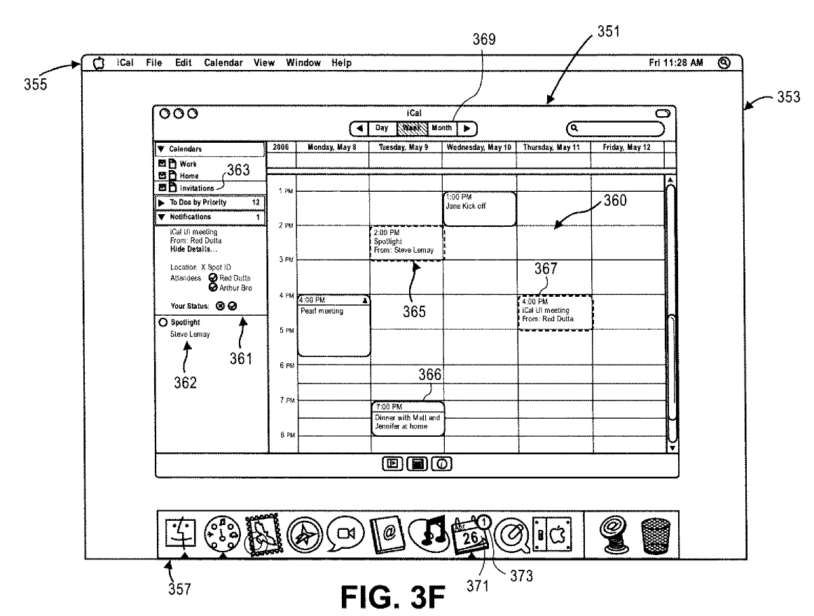

FIG. 2 shows a flow chart illustrating one or more exemplary embodiments of methods of the present inventions. The method of FIG. 2 begins in operation 201 in which a list of displayable calendars with selection commands is displayed. This list may be displayed within a calendar window and the selection commands may be displayed adjacent to each corresponding calendar which the command controls. Each command is selectable by a user to display or not display events from a particular calendar, thereby causing events to appear or not appear within the time range, such as a week view of a user's calendar. FIG. 3A shows an example of a user interface for a calendar application. The calendar application causes the display of a calendar window 301 which includes a view 302 of a user's calendar. In the example of FIG. 3A, the view is a week view, but it will be appreciated that alternative views may show a day view or a month view or other types of views. The view 302 shows an event 303 from the user's work calendar 309 shown in the list of displayable calendars 305. The view 302 also shows an event 304 from the user's home calendar 307, also shown in the list of selectable calendars 305. The list 305 also includes an invitation calendar 311. Each of the three calendars shown in the list 305 includes a respective selection command. In particular, the home calendar 307 includes a selection command 313, and the work calendar 309 includes a selection command 315, and the invitation calendar 311 includes a selection command 317. Each of these selection commands may be independently selected or not selected by the user, thereby causing events from the corresponding calendar to appear or not appear within the view 302 of the user's calendar. In the example shown in FIG. 3A, the user (or alternatively, software under default or other setting), has selected for display events from both the home calendar 307 and events from the work calendar 309 and thus check marks 316 and 318 appear within the corresponding selection commands 313 and 315. The selection commands may be activated in a variety of ways, including cursor inputs or keyboard inputs or speech inputs to the data processing system. For example, a user may position a cursor, as controlled by a mouse or other cursor control device, over the corresponding selection command and thereafter pressing a button, such as a mouse's button, to select the command or deselect the command. Also as shown in FIG. 3A, the invitation calendar has not been selected and thus there is no check mark in the selection command 317; hence, invitations from the invitation calendar which have not been accepted will not be displayed in the view 302. A notification 319 is also displayed within the window 301. This notification indicates that there is an unread invitation and tells the user to select the invitation calendar to see the unread invitation.

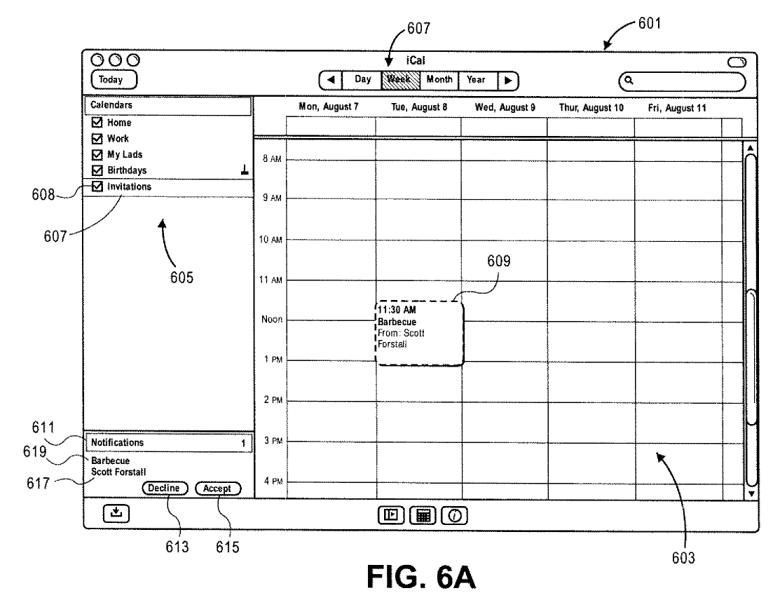

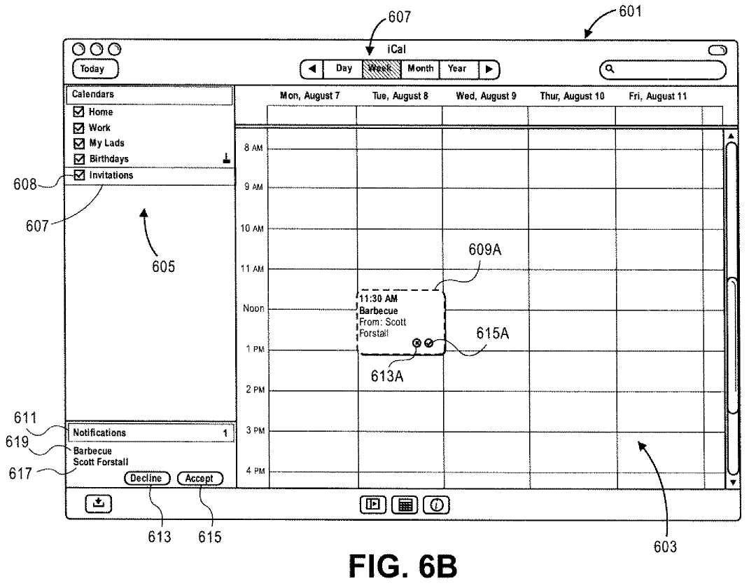

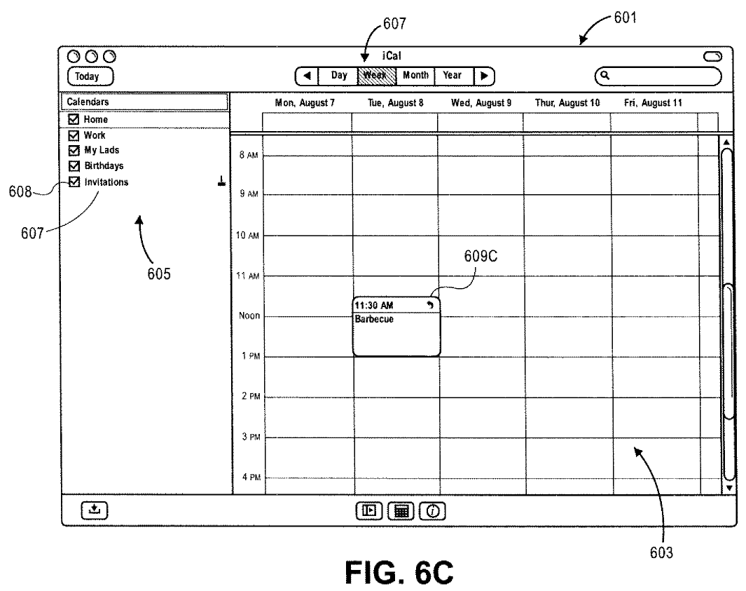

In response to the notification, the user may select the selection command 317 to cause invitations from the invitation calendar 311 to appear in the view 302. Alternatively, in response to an invitation, the system may automatically cause the selection of the selection command 317 to thereby cause unaccepted invitations to appear in the view 302 in the user's calendar. Referring back to FIG. 2, operation 203 involves receiving an input to cause the display of invitations from an invitation calendar onto a calendar displayed to a user. In response, in operation 205, invitations from the invitation calendar are displayed on a view of the user's calendar on a display device. FIG. 3B shows an example of such a view in which an unaccepted invitation from the invitation calendar is displayed in the view 302. A check mark 317A shows that the user has, or the system has, caused an input, which was received in operation 203, to thereby cause invitations to appear in the view 302. As shown in FIG. 3B, the home calendar and the work calendar have also been selected in the list 305 and hence events from both of those calendars are also displayed in the view 302 as shown in FIG. 3B. In particular, event 303 from the work calendar, event 304 from the home calendar, and the invitation 321 from the invitation calendar 311 are all concurrently displayed in the view 302. Events 303 and 304 are displayed in a fashion showing that they have been accepted, while the invitation 321 is displayed in a manner to show that it has not yet been accepted or declined. This is shown by the visual indicator 323. There are numerous alternative ways to show that the invitation 321 has not yet been accepted or declined in the view 302. For example, the unaccepted invitation may flash or be displayed with a coupon-like perimeter or displayed with text indicating it is not yet accepted, or displayed with “accept” and “reject” icons adjacent to the invitation on the view 302, etc. FIG. 3F shows a particular embodiment in which the invitations 365 and 367, which have not yet been accepted, are displayed in a view of a calendar while other events which have been accepted, such as event 366, is displayed differently. FIG. 6B shows an example in which an invitation which has not yet been accepted, such as invitation 609A, includes “accept” and “decline” icons which may also be used to differentiate an unaccepted invitation from other events which have been accepted. A user may decide, while viewing the user interface shown in FIG. 3B, to view only invitations from the invitation calendar, and this result is shown in FIG. 3E in which only the invitation calendar has been selected through the selection command 317, while the other selection commands 313 and 315 have been deselected, such that events from the home calendar and the work calendar do not appear in the view 302 shown in FIG. 3E. Hence, the list of selectable calendars 305 allows a user to toggle calendars on or off independently to focus on a particular calendar, although it will be appreciated that the user interface shown in FIG. 3B gives the user the ability to see the invitation which has not yet been accepted relative to other events in additional calendars beyond the invitation calendar. It will be understood that there may be a plurality of invitations which have not yet been accepted which are shown on the invitation calendar, and an example of this is shown in FIG. 3F which includes two unaccepted invitations 365 and 367 along with other events from selected calendars as shown in FIG. 3F. It will be appreciated that a user may remove the invitations from view 302 shown in FIG. 3B by deselecting the invitation calendar 311 in the list 305, and this will return the view to the state it was in FIG. 3A. This is also shown as operations 207 and 209 of FIG. 2.

The user may accept or decline an invitation by using one of a variety of different user interfaces as further described herein. FIGS. 3C and 3D show an example of the user interface of one embodiment after an invitation has been accepted. It can be seen from FIG. 3C that the view 302 now includes the event 321 which is an accepted invitation, and it is displayed as other events are also displayed which have been accepted. Thus, the appearance of the event 321 is similar to the appearance of the event 303. Also note that events from only the work calendar are now shown in the view 302, while events from the home calendar are not shown (and hence the event 304 is not shown in the view 302 of FIG. 3C). FIG. 3D shows the invitation calendar 311 only in the view 302. There are no invitations shown in the view 302 of FIG. 31) because the invitation related to event 321 has been accepted and hence it has been removed from the invitation calendar as shown in the view 302 of FIG. 3D.

FIG. 3F shows one example of a user interface according to one embodiment of the present inventions. This user interface includes a calendar window 351 shown on a desktop 353. A dock 357 is also shown on the desktop 353. The dock includes an icon 371 representing the calendar application which is running and causing the display of the calendar window 351. The dock also includes a notification icon 373 which indicates that the system has received one notification relating to an invitation. The user interface also includes a pull-down menu region 355. The calendar program window 351 includes a user interface 369 for selecting a time range, such as a week or day or month range for display of events within the view 360 of the user's calendar. As shown in FIG. 3F, the week range has been selected from the user interface 369, causing a week view to appear in the view 360. Numerous events from three different calendars (a work calendar, a home calendar, and an invitations calendar) are shown within the view 360. For example, event 366 from the home calendar is shown with several events from the work calendar. In addition, two invitations 365 and 367 are also shown in the view 360 concurrently with the other events from the other calendars. As with the example shown in FIG. 3A, the calendars may be selectively turned on or off, thereby displaying or not displaying events from a selected calendar. As can be seen from FIG. 3F, the invitations calendar 363 has been selected for display, causing the invitations 365 and 367 to appear without a particular color which is related to the other calendars and to appear with a coupon-like perimeter, indicating to the user that these events are invitations which have not yet been accepted. A notifications portion of the calendar program window 351 shows two notifications 361 and 362. The notification 361 has been expanded to show details about this particular notification which relates to the invitation 367 shown in a particular time on Thursday, May 11. Note that the invitations are shown at the particular time of the invitation on the view 360 and that the duration of the invitation is also shown by the area that the invitation spans on the view 360. This is similar to how the area of the events which have been accepted, such as event 366, also indicates the duration of the event. The notification 361 includes an “accept” icon and a “decline” icon for accepting or declining the invitation 367. In an alternative embodiment, these icons may be shown only when the invitation 367 is within the view 360 or in addition to the invitation 367 on the view 360.

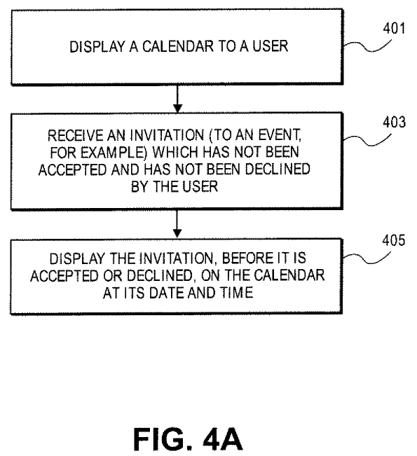

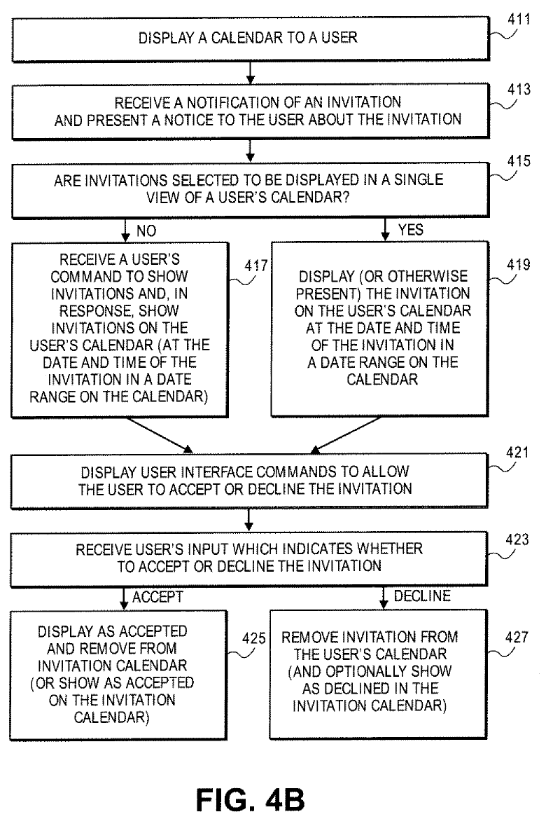

FIG. 4A is a flow chart indicating an exemplary method according to one aspect of the present inventions. In operation 401, a calendar is displayed to a user. Then in operation 403, an invitation to an event which has not yet been accepted and which has not yet been declined, is received. This invitation is displayed, in operation 405, before it is accepted or declined. It is displayed, in operation 405, on the calendar at its date and time and may include an indication of the duration of the event related to the invitation. Examples of user interfaces related to this method of FIG. 4A have been provided above, including, for example, the user interface in FIG. 3B and the user interface shown in FIG. 3F in which invitations are displayed before they are accepted or declined on the user's calendar at the date and time of the invitation.

FIG. 4B shows a more detailed method than the method of FIG. 4A, and this more detailed method is yet another exemplary embodiment according to at least one aspect of the present inventions. Examples of user interfaces which illustrate at least portions of this method have been provided herein, including, for example, FIGS. 3A, 3B, 3F, and other figures. In operation 411, the data processing system displays a calendar to a user. In operation 413, a notification of an invitation is received, and the data processing system presents a notice to the user about the invitation. It will be appreciated that in certain embodiments, the sequence of operations 413 and 411 may be reversed. For example, the calendar may be displayed in operation 411 after receiving the notification 413, and this may occur automatically in response to the notification. It will be also appreciated that various other sequences for other operations in the methods shown in FIG. 4B may be utilized by at least certain embodiments of the present inventions. In operation 415, it is determined whether or not invitations have been selected to be displayed in a view of a user's calendar. In one embodiment, this may involve determining whether or not a selection command, such as selection command 317, has been selected, either by the user or by the system. If it has not been selected, then operation 417 follows, and if it has been selected, then operation 419 follows as shown in FIG. 4B. In operation 417, the data processing system receives a user's command (or a system input or a programmatic input) to show the invitations, and in response, the invitations are shown on the user's calendar at the date and time of the invitation in a selected date range on the calendar. If the invitations had been selected, as determined in operation 415′ then operation 419 follows in which the invitation is displayed or otherwise presented on the user's calendar. In operation 421, user interface commands are displayed to allow the user to accept or decline the invitation. The user's input (or input from the system or a software program) is received in operation 423, which input indicates whether or not to accept or decline the invitation. If the invitation is accepted, then operation 425 follows, and if the invitation is declined, then operation 427 follows. In operation 425, the invitation is displayed as accepted and thus the event appears as other accepted events appear on the user's calendar. Optionally, the event which constitutes the invitation is also removed from the invitation calendar or is shown as accepted on the invitation calendar. In operation 427, if the operation is declined, then it is removed from the user's calendar and optionally shown as declined on the invitation calendar. In another embodiment, the declined event may also be removed from the invitation calendar in addition to removing it from the user's calendar.

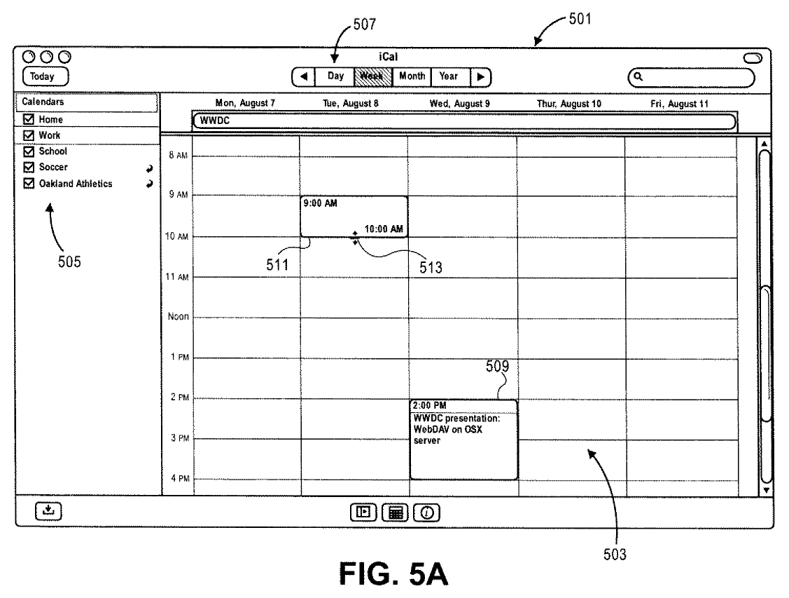

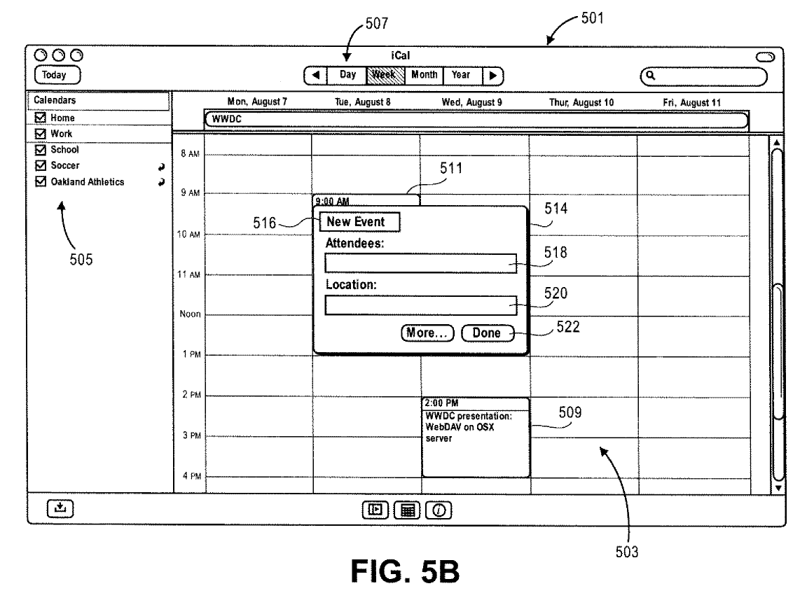

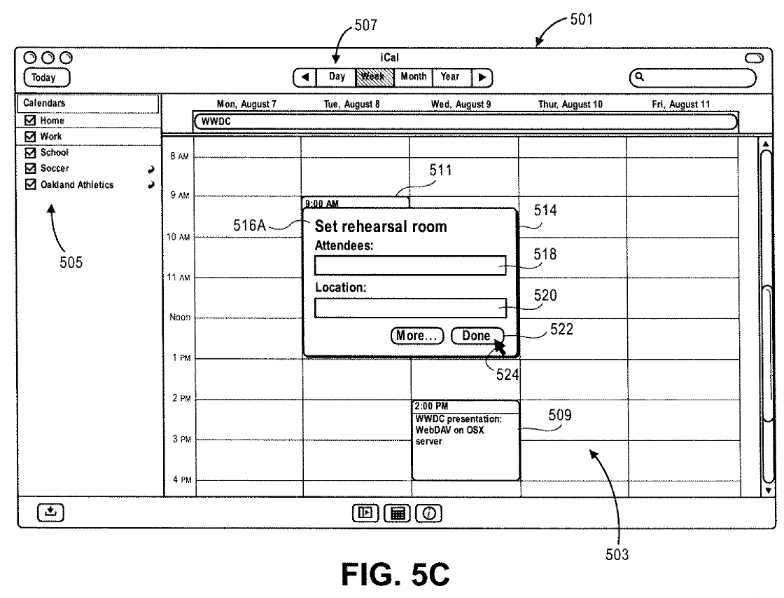

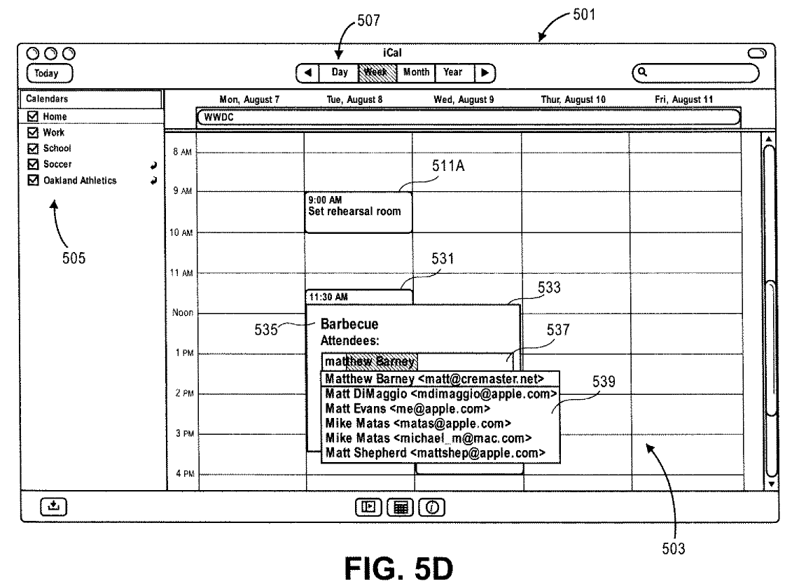

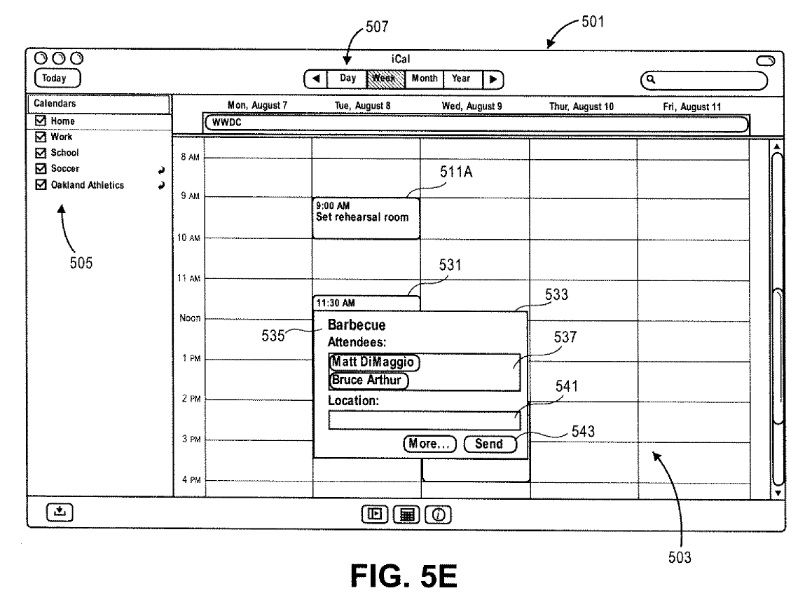

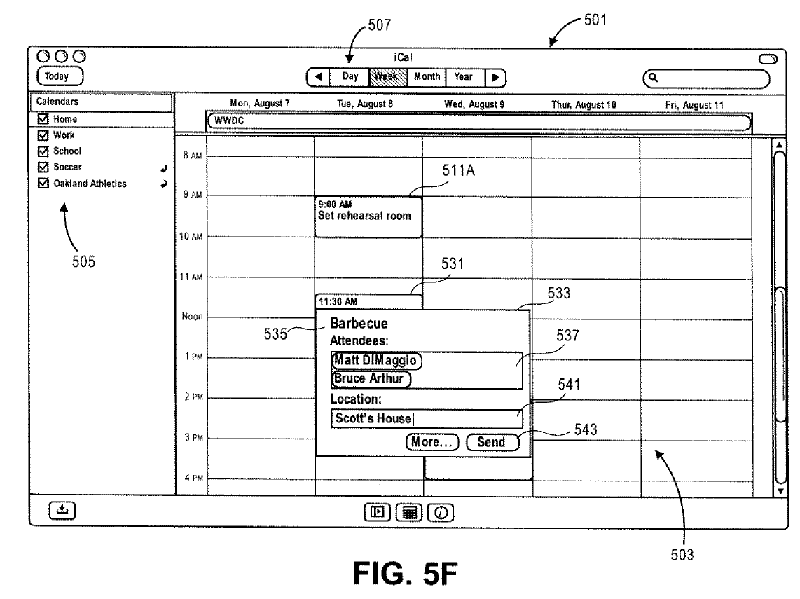

Additional examples of embodiments of user interfaces will now be provided by FIGS. 5A-5F and FIGS. 6A-6C. FIGS. 5A-5F show examples of how events are created within a calendar and how invitations may be created from the sender's side of an invitation. FIG. 5A shows an example of a calendar application window 501 which includes a view 503 of a user's calendar. This view may be selected to be at one of a plurality of different time ranges such as a day range or a week range or a month range or a year range, as determined by the range selector 507. In the particular example shown in FIG. 5A, an input has been received which instructed the system to display events within a week range in the view 503. The calendar application window 501 also includes a list 505 of selectable calendars, which in this case have all been selected for having their events displayed within the view 503. The view 503 includes an event 509, which has already been scheduled, and an event 511, which is currently being scheduled as shown in the example of FIG. 5A. The cursor 513 is being used to select the duration of the event 511 as shown in FIG. 5A. After the duration has been selected, a dialog window 514 is displayed, allowing user input into three fields 516, 518, and 520. The field 516 allows the user or the system to enter text which represents the name of the event or other information. The field 518 allows the user or the system to enter attendees; in certain embodiments, the user or the system may merely enter the first part of an attendee's name and the system will search through contact databases or address databases for that person's name and may include contact information, such as an email address or a phone number or other contact information which can be used to alert the attendees of the events/invitation as shown below. In the case of the example shown in FIGS. 5B and 5C, there will be no attendees, and thus the field 518 remains blank in both FIGS. 5C and 5B. Similarly, the location field 520 also remains blank. After the user has entered text into field 516 as shown in FIG. 5C, the user can then complete the entry of data for the event 511 by selecting the “done” button 522 by positioning a cursor 524 over the done button; in other embodiments, other inputs may be used to indicate that the user has completed entry of information with respect to an event. For example, the user may press a key, or button, such as a return button on a keyboard.

FIGS. 5D, 5E, and 5F show an example of user interfaces for creating an event and an invitation at the sender's side of the invitation. The sequence of user interfaces shown in FIGS. 5D, 5E, and 5F follow the sequence of user interfaces shown in FIGS. 5A, 5B, and 5C. Hence, the event 511 has turned into event 511A, as shown in FIG. 5D, because the user has completed entry of information in connection with that event which now appears in the view 503. The user, as shown in FIG. 5D, has begun creating a new event 531 which will also become an invitation because the event has two attendees. As shown in FIG. 5D, the user has entered a name for the event/invitation in a field 535 within the window 533 which accepts input for the event/invitation. The user has also entered a portion of one of the attendees' names within the field 537 which specifies the attendees. In response, the system returns a list of names which match the text entered into field 537. In particular, the system returns a list 539 from which the user can select one or more names for entry into the field 537. In the particular example shown in FIG. 5D, the attendees are specified by name and by email address and notifications about the invitation will be sent to the attendees by email. In alternative embodiments, other messaging techniques, such as telephone contacts, instant messaging addresses or contacts, etc. may be alternatively used or used in addition to email addresses. After a selection of the attendees as shown in FIG. 5D, the window 533 is ready to receive a location input into field 541 as shown in FIG. 5E. The user or the system then enters a location in the field 541 as shown in FIG. 5F and at this point the invitation is ready to be sent, and the event's data entry will be completed after the user selects the “send” button 543 as shown in FIG. 5F. Selecting that button will then cause the event to be displayed as event 531 on the sender's calendar and will also cause a notification, in this case by email, to be sent to the two attendees listed in field 537. In the embodiment discussed relative to FIGS. 6A-6C on the attendee's side, these emails are used to provide a notification from an email program to the calendaring program at the attendee's side so that the notification can be received directly within the calendaring window rather than merely in an email application window.

FIGS. 6A, 6B, and 6C illustrate the receipt of the invitation at the attendee's side of an invitation. In this particular example, the invitation created and sent from FIGS. 5D, 5E, and 5F is received at the attendee's side as shown in FIGS. 6A, 6B, and 6C. The attendee is using a data processing system which displays a calendar application window 601 which includes a view 603 showing a week time range in the view 603 as determined by the interface control 607 in which the week time range is selected. The calendar application window 601 also includes a list of selectable calendars which includes an invitation calendar 607 shown in the list 605. As can be seen from FIG. 6A, all of the calendars have been selected to show their events within the view 603. For example, the invitations calendar 607 has been selected to show its events, which in this case are unaccepted invitations as shown by the selection command 608, which includes a check mark in the selection command 608. The calendar application window 601 also shows the invitation 609 and a notification 611 within the window. The invitation 609 is shown in the view 603 in a form to indicate that it has not yet been accepted or declined. In the example shown in FIGS. 6A and 6B, this form includes a coupon-like perimeter which includes a dotted or dashed line. Further, the invitation is shown without any of the colors used to indicate other events for other calendars. For example, all events from the home calendar may be shown in red while events from the work calendar may be shown in green, etc. As noted above, other types of indicators may alternatively be used or used in addition to those mentioned to show that the event is an invitation which has not yet been accepted. The notification 611 results from the email sent from the sender's system as a result of selecting the send button 543 shown in FIG. 5F. Alternatively, the notification could arrive from an instant messaging message or other electronic messages or even an automated phone system caused to make a phone call by selecting the send button 543 which, in turn, is received automatically by a recipient's data processing system which in turn converts this into a notification, such as notification 611. Information within the notification 611 includes the name of the event 619 and the sender of the event or invitation 617. In addition, the invitation includes an “accept” icon 615 which may be used to accept the invitation, and a “decline” icon 613 which may be used to decline the invitation. FIG. 6B shows an alternative embodiment in which accept and decline icons also appear within the invitation itself on the calendar, such as within the view 603 as shown in FIG. 6B. In particular, a decline icon 613A and an accept icon 615A are shown within the invitation 609A as shown in the view 603. The user can accept the invitation by selecting either icon 615 or 615A shown in FIG. 6B, and can decline the invitation by selecting either icon 613 or 613A. Accepting the invitation causes the invitation to be removed, in at least certain embodiments, from the invitation calendar 607, and causes the event to be displayed as a normal event rather than an invitation as shown in FIG. 6C, in which the event 609C now becomes an event within the home calendar and assumes the color of events (e.g. red) of events within the home calendar.

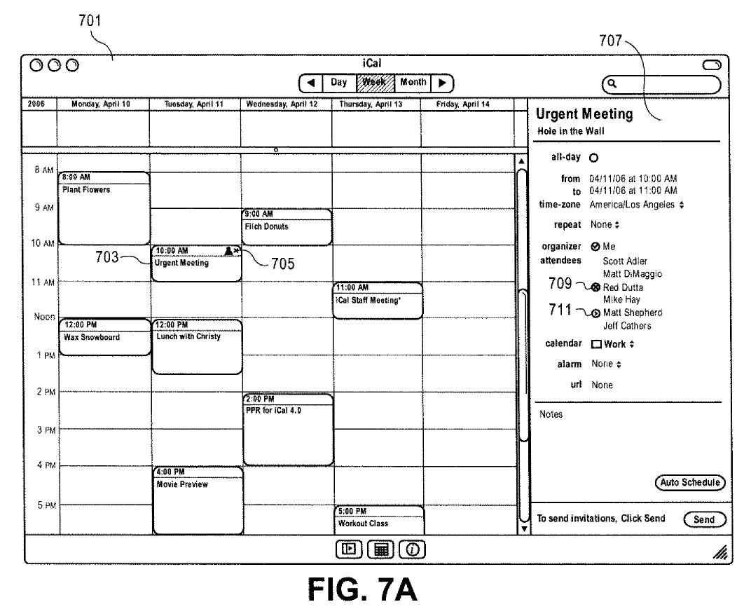

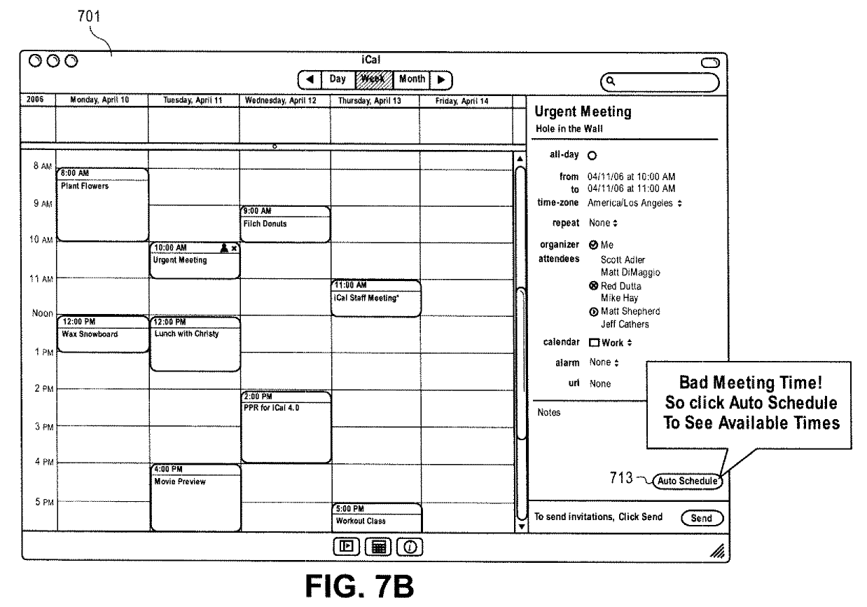

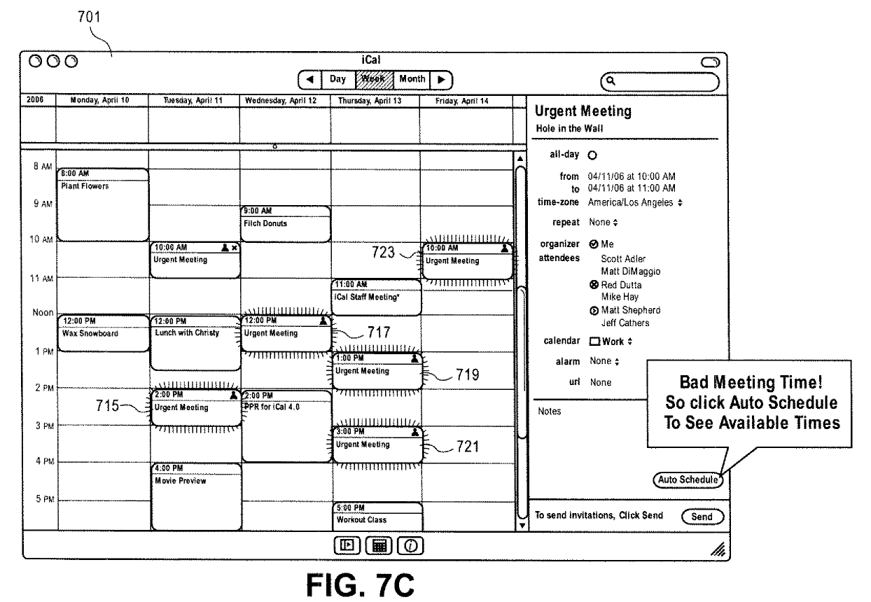

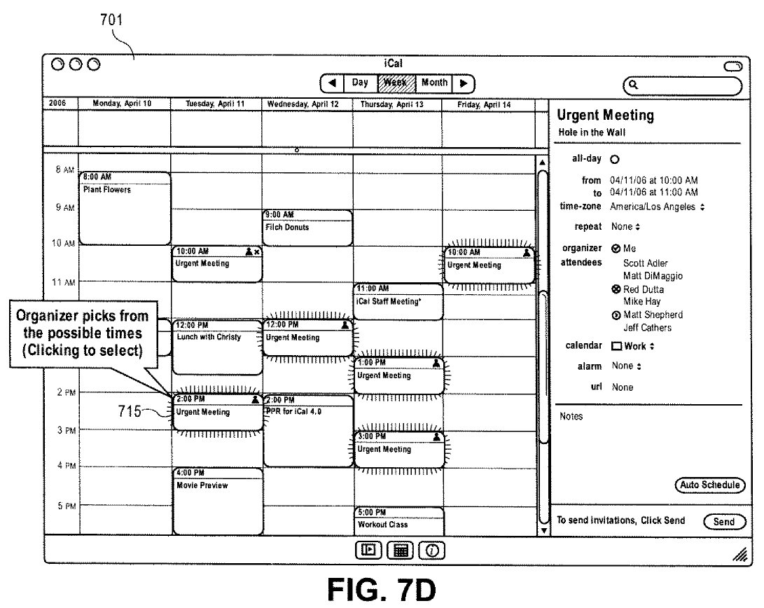

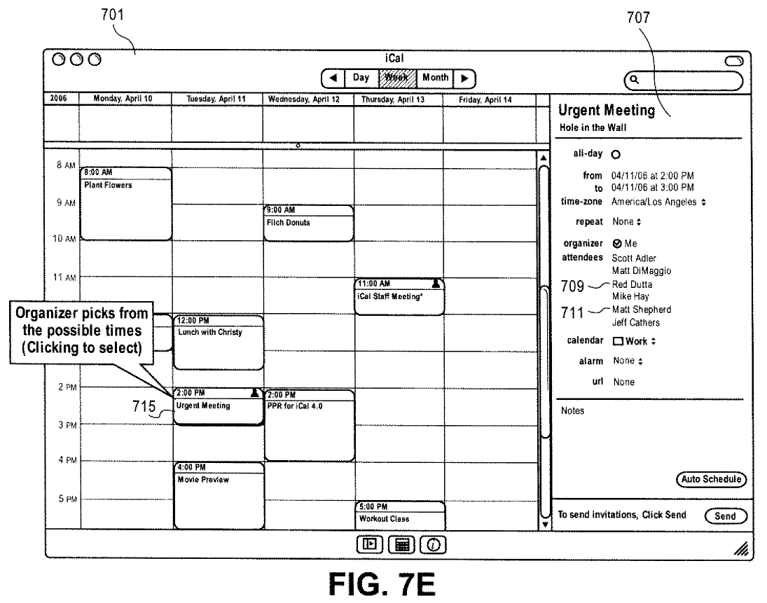

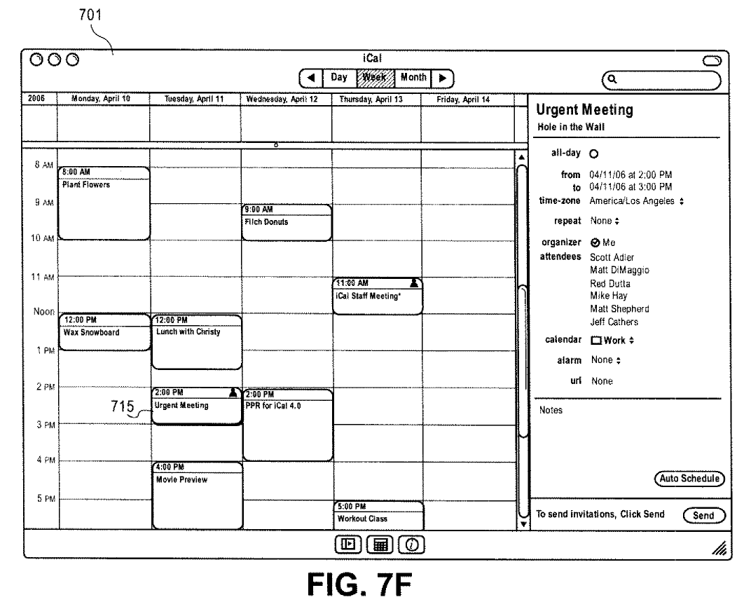

In another embodiment, as shown in FIGS. 7A, 7B, 7C, 7D, 7E and 7F, the calendar application enables an event creator to resolve scheduling conflicts for an event within a calendar window 701. FIG. 7A illustrates that event 703, scheduled at 10 A.M. on April 11, has a conflict with a least one attendee as shown by indicator 705. The event details 707 show that two people have either a full (709) or partial conflict (711) during the scheduled time as indicated by conflict icons. Under these circumstances, the creator may click an “Auto Schedule” button 713, as illustrated in FIG. 7B. In response, the calendar application visually indicates the time slots (715, 717, 719, 721, 723) on the creator's calendar when all attendees are available for the amount of time required for the event (FIG. 7C). These time slots may be on different days as well as at different times. The calendar application may also visually diminish, e.g., dim, the non-available time slots in the calendar window 701. The creator selects one of the available time slots, such as slot 715 (FIG. 7D), by clicking a pointing device or through some other navigation methodology. Looking at the event details 707 in FIG. 7E shows that the two people (709, 711) who had the original conflicts, now no longer have conflict icons next to their names. FIG. 7F illustrates the resulting calendar window 701 that has the event rescheduled for 2 P.M. on April 11, with the original scheduled time slot for the event now show as open on the creator's calendar.

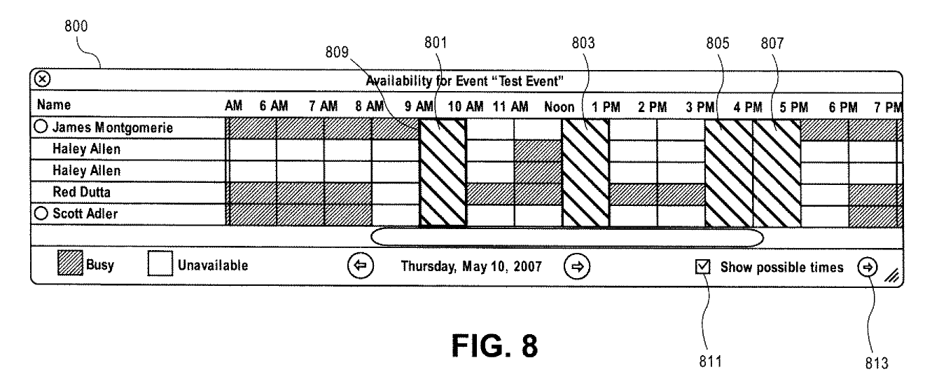

In an alternate embodiment shown in FIG. 8, the calendar application displays a separate window 800 containing free and busy timelines for the attendees. The window 800 shows the available time slots (801, 803, 805, 807) with visual characteristics, such as the illustrated hashing, to explicitly designate the availability of the attendees. The event time range is indicated by a marker 809. As the creator moves the marker 809 along the time line, it will snap to the next available time slot but other available time slots remain visible in the window 800. If the creator clicks on arrow 812, the calendar application automatically positions the event marker 809 on the first available time slot (“auto-pick”). While the calendar application attempts to find an available slot on the original day scheduled for the event, it will show available time slots on any future date and the creator can jump forward and back on the timelines to select a time slot. Because the window 800 shows all available time slots even though all attendees may not be visible, this embodiment allows the creator to quickly choose an appropriate time slot for the event without additional scrolling. It will be appreciated that the auto-pick capability can be incorporated into the calendar window availability function illustrated in FIGS. 7A-F to move the event to the first available time slot.

If box 811 is not checked, the creator can manually search the timelines for available time slots. Once the creator has selected a time slot, the event is populated with the scheduling details.

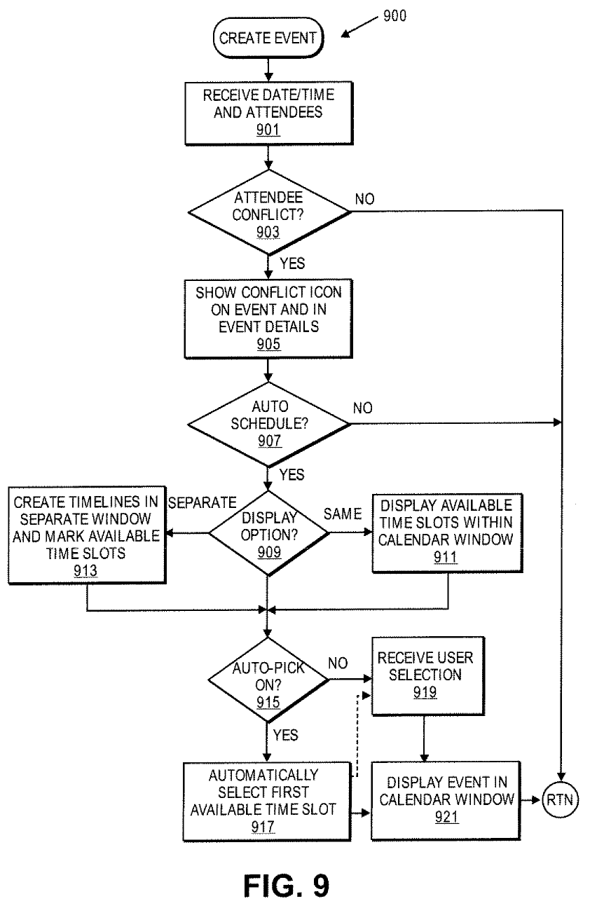

FIG. 9 illustrates one embodiment of the create event method 900 that is invoked by the calendar application to display available time slots as described above in conjunction with FIGS. 7A-8. At block 901, method 900 receives date and time information and a list of attendees from an event creator. At block 903, the method 900 determines whether any attendees have conflicts with the date and time of the event. If so, the create event method 900 displays a conflict icon on the event slot in the calendar window and a conflict icon in the events detail window next to each attendee that has a conflict (block 905). If auto schedule is selected (block 907), the method 900 determines whether to display the free/busy information in a separate window or within the calendar window (block 909). If the display option is to show the free/busy information in a separate window, method 900 creates timelines in a separate window marks available time slots as illustrated in FIG. 8 at block 913. If the display option is to display the free/busy information in the same window, the method 900 displays the available time slots within a calendar window as previously described in conjunction with FIGS. 7A-F (block 911). If auto-pick is on (block 915), the method 900 selects the first available event at block 917. Otherwise, the method 900 receives a user selection of a new time and date at block 919. In an alternate embodiment of auto-pick, the user may choose to ignore the first available slot as shown by the dashed arrow from block 917 to block 919. The method 900 displays the event at the selected time and date in the calendar window at block 921 to reschedule the event. Once the create event method 900 has completed its functions, it returns to the calendar application.

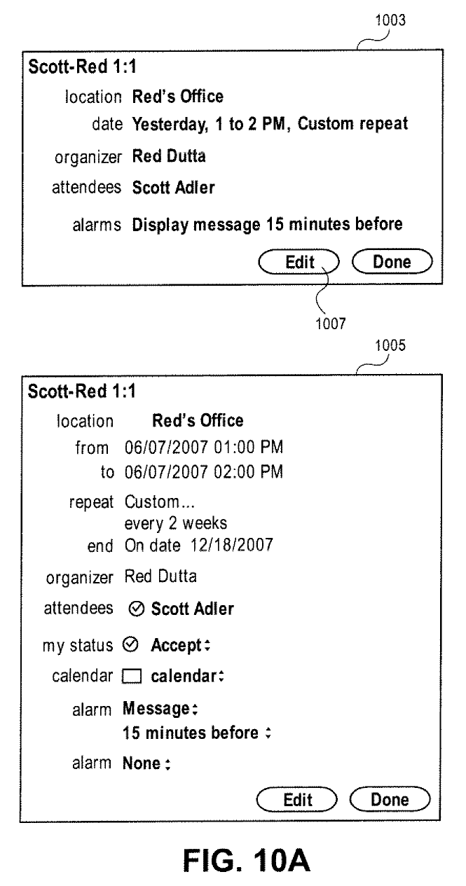

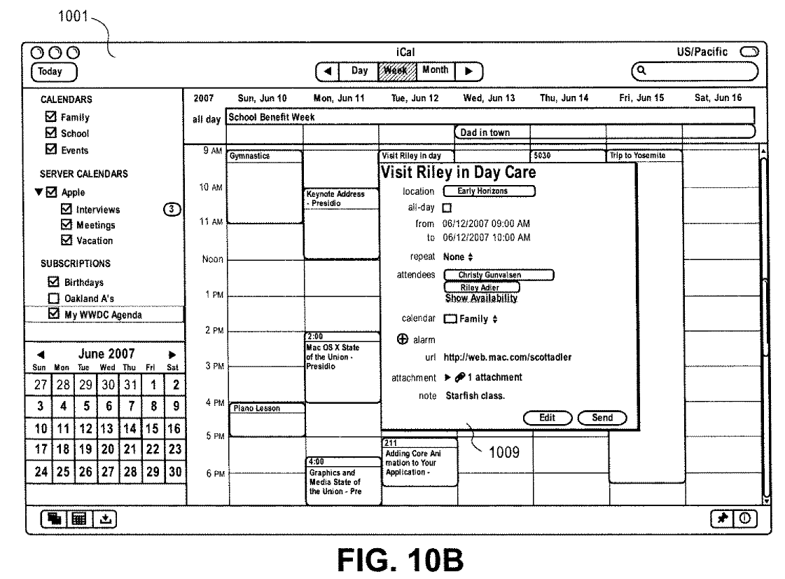

FIGS. 10A and 10B illustrate in-line inspector windows that are displayed with a calendar window. In the embodiment shown in FIGS. 10A and 10B, the inspector windows do not have the user controls found in a standard window. FIG. 10A shows a condensed read-only mode 1003 for event details, and a full edit mode 1005 in which some or all of the details can be edited, depending on user privileges. The calendar application opens the condensed inspector window 1003 within the calendar window when the user selects an event, such as by moving and pausing a cursor over the event or by clicking a pointing device. If the user further clicks on an “edit” button 1007, the calendar application opens a full inspector window 1005 within a calendar window. In one embodiment, the calendar application also displays an inspector window when the details for an event are changed and visually indicates the changed details, such as by highlighted them.

As shown in FIG. 10B, the calendar application positions the full inspector window 1009 within the calendar window 1001 to be anchored to the corresponding event while remaining within the calendar window. Although not illustrated, it will be appreciated that the positioning function applies equally to the condensed inspector window 1003. The user may move either of the inspector windows 1003, 1005 outside a calendar window. In response, the calendar application will position the inspector window on the screen to overlay as few other windows as possible while keeping the inspector window fully on the screen.

The calendar application can also display either in-line inspector window 1003, 1005 when an event is modified. The calendar application compares the old and new events, and highlights the changed details in the inspector window.

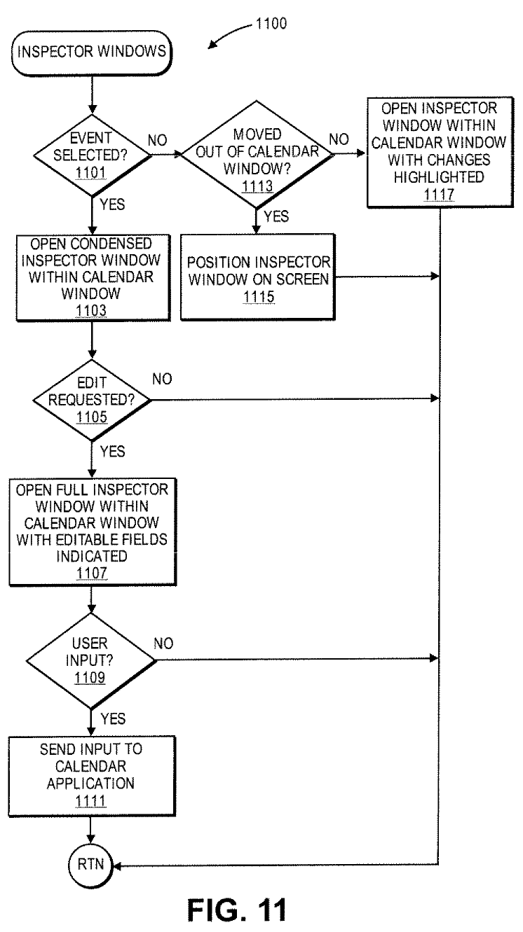

FIG. 11 illustrates one embodiment of inspector windows method 1100 that is invoked by the calendar application to open an inspector window, to position an inspector window outside the calendar window, or to display an inspector window when a change has occurred to calendar event. Method 1100 determines if an event has been selected by a user (block 1101) and opens a condensed inspector window within a calendar window if so (block 1103). If an edit request is received (block 1105), such as a result of a user clicking on an edit button, the method 1100 opens a full inspector window within the calendar window and marks of the fields that can be edited in some visual fashion, such as through highlighting (block 1107). If the method 1100, receives user input through the full inspector window (block 1109), the input is sent to the calendar application at block 1111.

Returning now to block 1101, if an event has not been selected by a user, the method 1100 determines if an existing inspector window has been moved out of the calendar window at block 1113. If so, at block 1115, the method 1100 positions the inspector window on the screen to avoiding overlaying as many existing windows as possible while remaining on the screen. If the method 1100 is invoked because of a change to an event, at block 1117 the method 1100 opens an inspector window anchored on the event within a calendar window and highlights the change. When the method 1100 completes its functions, it returns to the calendar application.

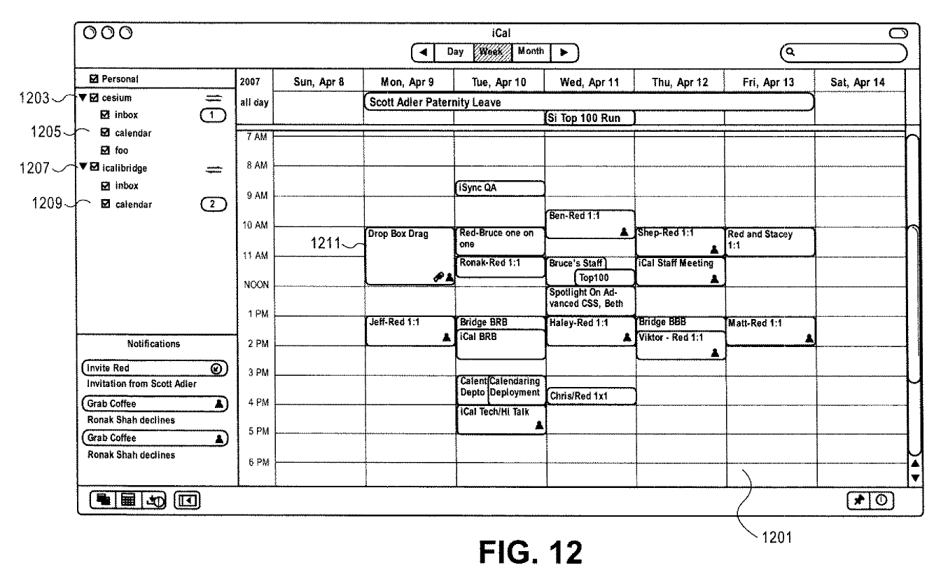

In another embodiment, the calendar application displays calendars from multiple accounts for an individual within the same calendar view as shown in FIG. 12. As illustrated, the user has an account on server “cesium” 1203, and an account on server “icalbridge” 1207. Each account contains a calendar, calendar 1205 for cesium 1203 and calendar 1209 for icalbridge 1207. An event 1211 for calendar 1205 is shown merged with the events for calendar 1209 in calendar view 1201.

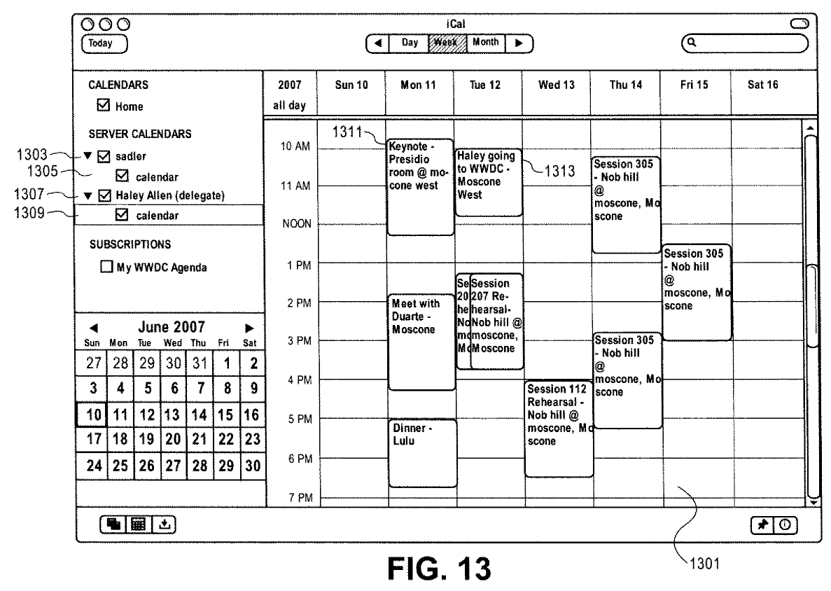

FIG. 13 illustrates calendars for multiple accounts being merged into a single calendar view 1301 when one of the accounts belongs to a different user. Calendar 1305 is part of account “sadler” 1303 and calendar 1309 is part of account “Haley Allen” 1307, the owner of which has delegated access to the calendar 1309 (i.e., account 1307 is a delegated account). Event 1313 from calendar 1309 is displayed within the same calendar view 1301 as event 1311 from calendar 1305.

It will be appreciated that one or more of the multiple accounts may be on the same server. In this embodiment, the calendar application schedules events within calendar views 1201, 1301 in view of the existing events for the multiple calendars. In addition, a timeline window, such as illustrated in FIG. 8, will reflect the free/busy time for all calendars merged into a single calendar window.

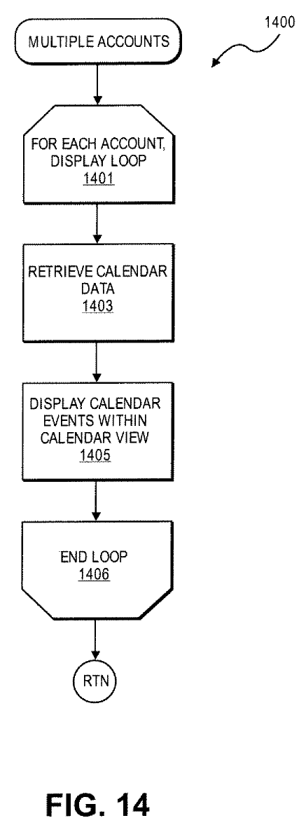

FIG. 14 illustrates one embodiment of a multiple accounts method 1400 that is invoked by the calendar application to merge the events from multiple calendars within a single calendar view. Method 1400 performs a display loop from block 1401 until block 1406 for each account to be displayed in a single calendar view. For each account, method 1400 retrieves calendar data at block 1403 and displays that calendar's events within the calendar view at block 1405. When all of accounts to be displayed within a single calendar view have been processed, method 1400 returns to the calendar application.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine readable medium containing executable program instructions which cause a data processing system to perform a method comprising:
determining a conflict for an attendee to an event that is scheduled at an original time;
calculating available time slots for all attendees to the event;
visually indicating the available time slots within a calendar window that also displays the event at the original time; and
rescheduling the event in one of the available time slots.

2. The machine readable medium of claim 1, wherein the method further comprises:
automatically selecting a first available time slot.

3. The machine readable medium of claim 2, wherein the method further comprises:
determining the first available time slot based on the original time.

4. The machine readable medium of claim 1, wherein the method further comprises:
receiving a user selection of an available time slot.

5. The machine readable medium of claim 1, wherein the method further comprises:
determining a display option; and
visually indicating the available time slots within a timeline window that is separate from the calendar window if specified by the display option.

6. The machine readable medium of claim 5, wherein the method further comprises:
snapping an event marker to a next available time slot in response to a user moving the event marker.

7. The machine readable medium of claim 1, wherein the method further comprises:
visually diminishing non-available time slots.

8. A machine implemented method comprising:
determining a conflict for an attendee to an event that is scheduled at an original time;
calculating available time slots for all attendees to the event;
visually indicating the available time slots within a calendar window that also displays the event at the original time; and
rescheduling the event in one of the available time slots.

9. The machine implemented method of claim 8 further comprising:
automatically selecting a first available time slot.

10. The machine implemented method of claim 9 further comprising:
determining the first available time slot based on the original time.

11. The machine implemented method of claim 9 further comprising:
receiving a user selection of an available time slot.

12. The machine implemented method of claim 9 further comprising:
determining a display option; and
visually indicating the available time slots within a timeline window that is separate from the calendar window if specified by the display option.

13. The machine implemented method of claim 12 further comprising:
snapping an event marker to a next available time slot in response to a user moving the event marker.

14. The machine implemented method of claim 8 further comprising:
visually diminishing non-available time slots.

15. A data processing system comprising:
means for determining a conflict for an attendee to an event that is scheduled at an original time;
means for calculating available time slots for all attendees to the event;
means for visually indicating the available time slots within a calendar window that also displays the event at the original time; and
means for rescheduling the event in one of the available time slots.

16. The data processing system of claim 15 further comprising:
means for automatically selecting a first available time slot.

17. The data processing system of claim 15 further comprising:
means for determining a display option; and
means for visually indicating the available time slots within a timeline window that is separate from the calendar window if specified by the display option.

18. A machine readable medium containing executable program instructions which cause a data processing system to perform a method comprising:
receiving a user selection of an event; and
opening a condensed inspector window within a calendar window in response to the user selection, the condensed inspector window displaying a summary of the event.

19. The machine readable medium of claim 18, wherein the method further comprises:
receiving an edit request; and
opening a full inspector window within a calendar window in response to receiving the edit request, the full inspector window displaying details of the event and indicating details editable by the user.

20. The machine readable medium of claim 19, wherein the method further comprises:
positioning one of the inspector windows outside the calendar window in response to a user moving the one of the inspector windows outside the calendar window.

21. A machine implemented method comprising:
receiving a user selection of an event; and
opening a condensed inspector window within a calendar window in response to the user selection, the condensed inspector window displaying a summary of the event.

22. The machine implemented method of claim 21 further comprising;
receiving an edit request; and
opening a full inspector window within a calendar window in response to receiving the edit request, the full inspector window displaying details of the event and indicating details editable by the user.

23. The machine implemented method of claim 21 further comprising:
positioning one of the inspector windows outside the calendar window in response to a user moving the one of the inspector windows outside the calendar window.

24. A data processing system comprising:
means for receiving a user selection of an event; and
means for opening a condensed inspector window within a calendar window in response to the user selection, the condensed inspector window displaying a summary of the event.

25. The data processing system of claim 24 further comprising:
means for receiving an edit request; and
means for opening a full inspector window within a calendar window in response to receiving the edit request, the full inspector window displaying details of the event and indicating details editable by the user.

26. A machine readable medium comprising:
detecting a change to an event;
opening an inspector window anchored on the event within a calendar window; and
visually indicating the change in the inspector window.

27. A machine implemented method comprising:
detecting a change to an event;
opening an inspector window anchored on the event within a calendar window; and
visually indicating the change in the inspector window.

28. A data processing system comprising:
means for detecting a change to an event;
means for opening an inspector window anchored on the event within a calendar window; and
means for visually indicating the change in the inspector window.

29. A machine readable medium containing executable program instructions which cause a data processing system to perform a method comprising:
retrieving calendar data for a plurality of accounts accessible by a user; and
merging calendar events from each of the plurality of accounts in a single calendar view to display to the user.

30. The machine readable medium of claim 29, wherein at least two of the plurality of accounts are hosted on different servers.

31. The machine readable medium of claim 29, wherein one of the plurality of accounts is a delegated account.

32. A machine implemented method comprising:
retrieving calendar data for a plurality of accounts accessible by a user; and
merging calendar events from each of the plurality of accounts in a single calendar view to display to the user.

33. The machine implemented method of claim 32, wherein at least two of the plurality of accounts are hosted on different servers.

34. The machine implemented method of claim 32, wherein one of the plurality of accounts is a delegated account.

35. A data processing system comprising
means for retrieving calendar data for a plurality of accounts accessible by a user; and
means for merging calendar events from each of the plurality of accounts in a single calendar view to display to the user.
